(19) United States
(12) Patent Application Publication
(10) Pub. No.: US 2024/0300025 A1
(43) Pub. Date: Sep. 12, 2024

(54) LATHE PROTECTIVE COVER

(71) Applicant: National Chung Cheng University, Minsyong Township (TW)

(72) Inventors: Hsiang-Chen Wang, Minsyong Township (TW); Arvind Mukundan, Minsyong Township (TW); Riya Karmakar, Minsyong Township (TW); Shubham Nitin Pawar, Minsyong Township (TW)

(73) Assignee: National Chung Cheng University, Minsyong Township (TW)

(21) Appl. No.: 18/334,887

(22) Filed: Jun. 14, 2023

(30) Foreign Application Priority Data
Mar. 6, 2023 (TW) 112108107

(51) Int. Cl. B23B 25/04

(52) U.S. Cl. CPC B23B 25/04

(57) ABSTRACT

A lathe protective cover includes a mounting member and a cover unit. The mounting member has a main body including a mounting portion and a pivot portion, is configured to be detachably mounted on and configured to be movable relative to a cutter seat or a workpiece seat of a lathe. The cover unit includes a base plate pivotally connected to the pivot portion and having a through hole, and first and second side plates connected to two opposite sides of and cooperating with the base plate to define a shielding space communicating with the through hole. The cover unit is rotatable relative to the mounting member between a closed position, in which the mounting portion is adjacent to the through hole, and an open position, in which the shielding space and the through hole are away from the mounting portion.

### CROSS-REFERENCE TO RELATED APPLICATION

This application claims priority to Taiwanese Invention Patent Application No. 112108107, filed on Mar. 6, 2023.

### FIELD

The disclosure relates to a protective cover, more particularly to a lathe protective cover.

### BACKGROUND

A conventional protective cover device is suitable for mounting on a lathe which includes a base, a workpiece seat disposed on the base, and a cutter seat disposed on the base and cooperating with the workpiece seat to define a cutting space. The protective cover device includes a sliding seat disposed on the workpiece seat, and a cover slidably mounted on the sliding seat for covering the cutting space. However, to assemble the conventional protective cover device, it is necessary to mount the sliding seat onto the workpiece seat first, after which the cover is mounted onto the sliding seat, so that the conventional protective cover device has a complicated structure, and is inconvenient to assemble. Furthermore, it is necessary to design different sizes of sliding seats and covers for different types of lathes, so that the manufacturing cost thereof is also high.

### SUMMARY

Therefore, an object of the present disclosure is to provide a lathe protective cover that can alleviate at least one of the drawbacks of the prior art.

According to this disclosure, the lathe protective cover is adapted to be mounted on a lathe through cooperation of a fixing member, and includes a mounting member and a cover unit. The lathe includes a workpiece seat, and a cutter seat movable relative to the workpiece seat in a first direction. The mounting member has a main body including a mounting portion and a pivot portion opposite to the mounting portion, is configured to be detachably mounted on one of the cutter seat and the workpiece seat through the fixing member, and is configured to be movable relative to the one of the cutter seat and the workpiece seat along the first direction. The cover unit includes a base plate pivotally connected to the pivot portion and having a through hole, a first side plate connected to one side of the base plate, and a second side plate connected to the other side of the base plate and opposite to the first side plate in a second direction perpendicular to the first direction.

The base plate, the first side plate and the second side plate cooperatively define a shielding space communicating with the through hole. The cover unit is rotatable relative to the mounting member about a first axis between a closed position and an open position. When the cover unit is in the closed position relative to the mounting member, the mounting member is located in the shielding space, and the mounting portion is adjacent to the through hole in a third direction perpendicular to the first direction and the second direction. When the cover unit is in the open position relative to the mounting member, the shielding space and the through hole are away from the mounting portion.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is an assembled perspective view of a lathe protective cover according to an embodiment of the present disclosure mounted on a lathe with a cover unit thereof in an open position relative to a mounting member.

FIG. 2 is an exploded perspective view of the embodiment.

FIG. 3 is an assembled perspective view of the embodiment, illustrating the cover unit in a closed position relative to the mounting member.

FIG. 4 is a view similar to FIG. 1, but with the cover unit in the closed position relative to the mounting member.

FIG. 5 is a top view of FIG. 4.

FIG. 6 is a side view of FIG. 4.

FIG. 7 is a view similar to FIG. 1, but illustrating a second transparent plate partially covering a cutout portion of a second frame-shaped body of a second side plate.

### DETAILED DESCRIPTION

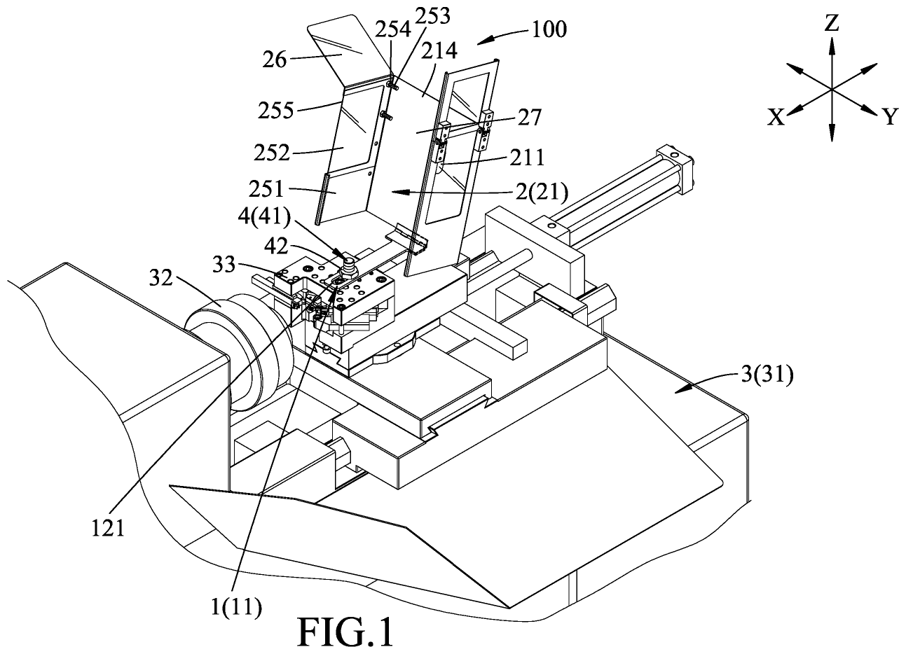

Referring to FIGS. 1 to 3, a lathe protective cover 100 according to an embodiment of the present disclosure is adapted to be mounted on a lathe 3 through cooperation of a fixing member 4. The lathe 3 includes a machine frame 31, a workpiece seat 32 disposed on the machine frame 31, and a cutter seat 33 disposed on the machine frame 31 and movable relative to the workpiece seat 32 in a first direction (X). The fixing member 4 includes a threaded bolt 41 and a threaded nut 42. The lathe protective cover 100 includes a mounting member 1 and a cover unit 2.

The mounting member 1 is detachably mounted on the cutter seat 33, and has a main body 11 including a mounting portion 12 and a pivot portion 13 opposite to the mounting portion 12. The mounting portion 12 has a mounting hole 121. The threaded bolt 41 extends through a top surface of the cutter seat 33 and the mounting hole 121, and the threaded nut 42 is threaded to the threaded bolt 41 so as to fix the mounting portion 12 to the top surface of the cutter seat 33. In this embodiment, the mounting hole 121 is elongated in the first direction (X). As such, after the threaded nut 42 is loosened, the position of the mounting member 1 relative to the cutter seat 33 can be adjusted along the first direction (X). It should be noted that, in other variations of this embodiment, the mounting member 1 may be mounted on the workpiece seat 32, and is not limited to what is disclosed herein.

The cover unit 2 includes a base plate 21, a first side plate 22, a side cover plate 23, two hinge assemblies 24, a second side plate 25, and an inclined plate 26.

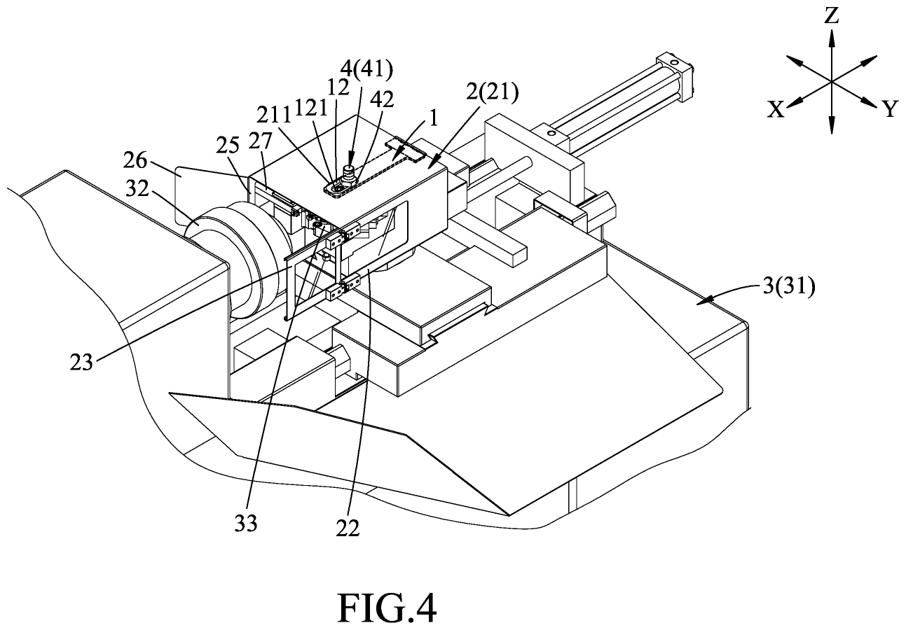

The base plate 21 has a through hole 211, two connecting edges 212, 212′ located at two opposite sides of the through hole 211 along a second direction (Y) perpendicular to the first direction (X), a pivoting edge 213 connected between the connecting edges 212, 212′ and pivotally connected to the pivot portion 13, and a free end 214 connected between the connecting edges 212, 212′ and opposite to the pivoting edge 213. The through hole 211 is also elongated in the first direction (X), and has an opening area larger than an opening area of the mounting hole 121. By pivotally connecting the pivoting edge 213 to the pivot portion 13, the cover unit 2 can be rotated relative to the mounting member 1 about a first axis (L1) between an open position (see FIG. 1) and a closed position (see FIG. 4) which will be described in detail later.

The first side plate 22 includes a first frame-shaped body 221 connected to the connecting edge 212, and a first transparent plate 222 disposed on the first frame-shaped body 221.

The side cover plate 23 includes a side cover frame-shaped body 231, and a side cover transparent plate 232 disposed on the side cover frame-shaped body 231. The side cover frame-shaped body 231 is pivotally connected to the first frame-shaped body 221 through the hinge assemblies 24, and is adjacent to the free end 214. The side cover frame-shaped body 231 is rotatable relative to the first frame-shaped body 221 about a second axis (L2) perpendicular to the first axis (L1).

The hinge assemblies 24 are disposed between the side cover frame-shaped body 231 and the first frame-shaped body 221, and are spaced apart from each other along the second axis (L2). Each hinge assembly 24 includes a first rod 241, a second rod 242, and a hinge pin 243.

The first rod 241 has a first main body 2410 connected to the first frame-shaped body 221, and two first pivot lugs 244 protruding from one end of the first main body 2410 in a direction away from the first frame-shaped body 221 and spaced apart in the second axis (L2). The second rod 242 has a second main body 2420 connected to the side cover frame-shaped body 231, and a second pivot lug 245 protruding from one end of the second main body 2420 into a space between the first pivot lugs 244. The hinge pin 243 is inserted into the first and second pivot lugs 244, 245 along the second axis (L2), so that the second rod 242 is rotatable relative to the first rod 241. In other variations of this embodiment, the positions of the first and second rods 241, 242 may be interchanged, that is, the first main body 2410 may be connected to the side cover frame-shaped body 231, while the second main body 2420 may be connected to the first frame-shaped body 221, but not limited thereto.

The second side plate 25 includes a second frame-shaped body 251 connected to the connecting edge 212′ and opposite to the first frame-shaped body 221 along the second direction (Y), a second transparent plate 252 detachably disposed on the second frame-shaped body 251, two screw bolts 253, and two screw nuts 254. The second side plate 25, the base plate 21 and the first side plate 22 cooperatively define a shielding space 27 communicating with the through hole 211.

The second frame-shaped body 251 has a rectangular cutout portion 255, and four first binding portions 256 adjacent to the connecting edge 212′ and equally spaced apart from each other along a length of the second frame-shaped body 251. The second transparent plate 252 covers the cutout portion 255, and has two second binding portions 257 alignable with any two adjacent ones of the first binding portions 256. In this embodiment, each first binding portion 256 is a hole penetrating through the second frame-shaped body 251, and each second binding portion 257 is a hole penetrating through the second transparent plate 252. Further, the screw bolts 253 are inserted through two adjacent ones of the first binding portions 256 that are adjacent to the free end 214 and the second binding portions 257, after which the screw nuts 254 are respectively engaged with the screw bolts 253 to fix the second transparent plate 252 to the second frame-shaped body 251, so that the second transparent plate 252 can completely cover the cutout portion 255.

The inclined plate 26 extends inclinedly from a side of the second frame-shaped body 251 that is adjacent to the free end 214 in a direction away from the first side plate 22.

With reference to FIGS. 1 to 4, after the lathe protective cover 100 is mounted on the cutter seat 33, the cover unit 2 is rotatable relative to the mounting member 1 about the first axis (L1) between the open position, in which the cover unit 2 is farther from the workpiece seat 32 than the mounting portion 12, and the closed position, in which the cover unit 2 can cover an outer portion of the cutter seat 33 and two opposite sides of the workpiece seat 32.

As shown in FIG. 1, when the cover unit 2 is in the open position relative to the mounting member 1, the shielding space 27 and the through hole 211 in the base plate 21 are away from the mounting portion 12, and a rotating angle of the base plate 21 relative to the mounting member 1 is greater than 90 degrees. At this time, a cutter (not shown) on the cutter seat 33 or a workpiece (not shown) on the workpiece seat 32 may be changed or adjusted, or the workpiece seat 32 and the cutter seat 33 may be cleaned. In this embodiment, when the cover unit 2 is not blocked by a foreign object, it can be rotated relative to the mounting member 1 to an angle of more than 180 degrees until the base plate 21 abuts against the machine frame 31.

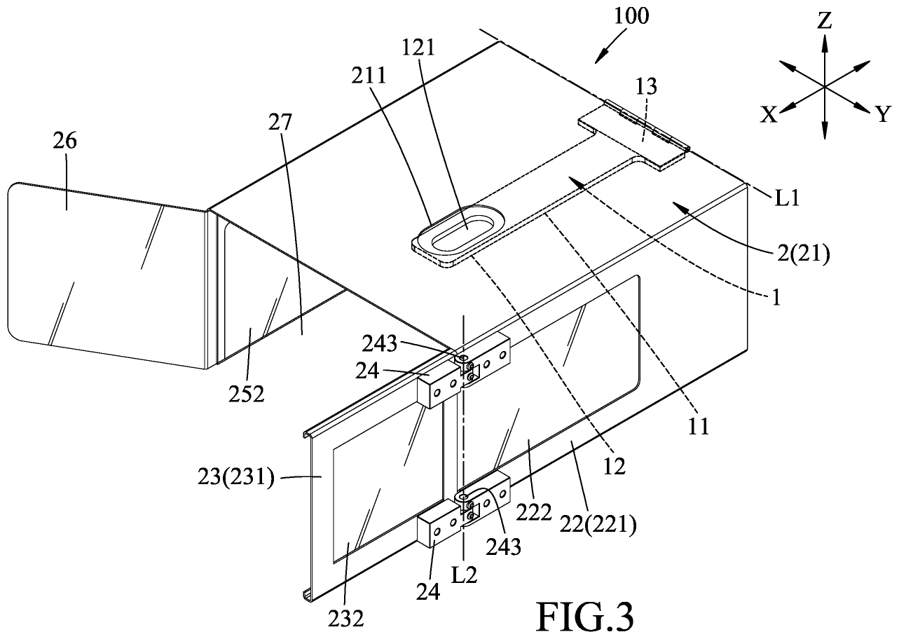

Referring to FIGS. 3 to 5, when the cover unit 2 is in the closed position relative to the mounting member 1, the cover unit 2 covers the workpiece seat 32 and the cutter seat 33, the mounting member 1 is located in the shielding space 27 and the mounting hole 121 is immediately adjacent to and aligned with the through hole 211 in a third direction (Z) perpendicular to the first and second directions (X, Y), and the threaded bolt 41 protrudes out of the through hole 211 for threaded connection with the threaded nut 42. Moreover, a profile range of the through hole 211 contains a profile range of the mounting hole 121, so that the mounting hole 121 is completely exposed from the through hole 211 when viewed from a top side of the base plate 21 that is opposite to the mounting member 1. The first and second side plates 22, 25 are located at two opposite sides of the cutter seat 33 in the second direction (Y), and the side cover plate 23 and the inclined plate 26 are located at two opposite sides of the workpiece seat 32 in the second direction (Y). In this embodiment, the first direction (X) is a front-rear direction, the second direction (Y) is a left-right direction, and the third direction (Z) is an up-down direction, as shown in FIG. 4. Hence, the mounting hole 121 is located below the through hole 211, and is exposed from the through hole 211 when viewed from the top side of the base plate 21. Further, because the through hole 211 is larger than the mounting hole 121, the base plate 21 can be prevented from being stuck by the threaded bolt 41 and the threaded nut 42, so that it can remain horizontally abutting against the mounting member 1.

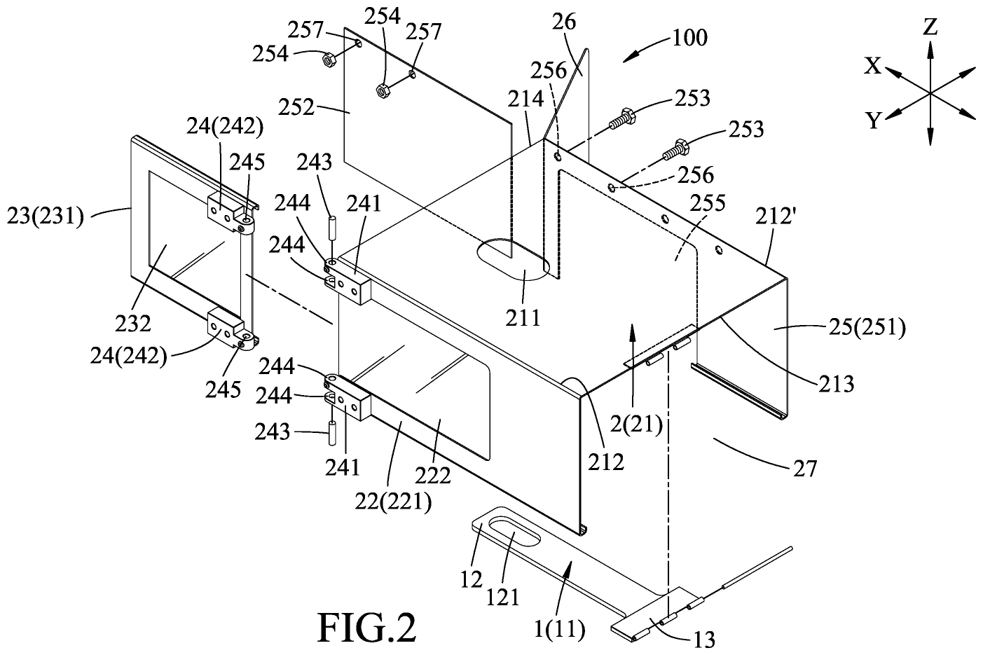

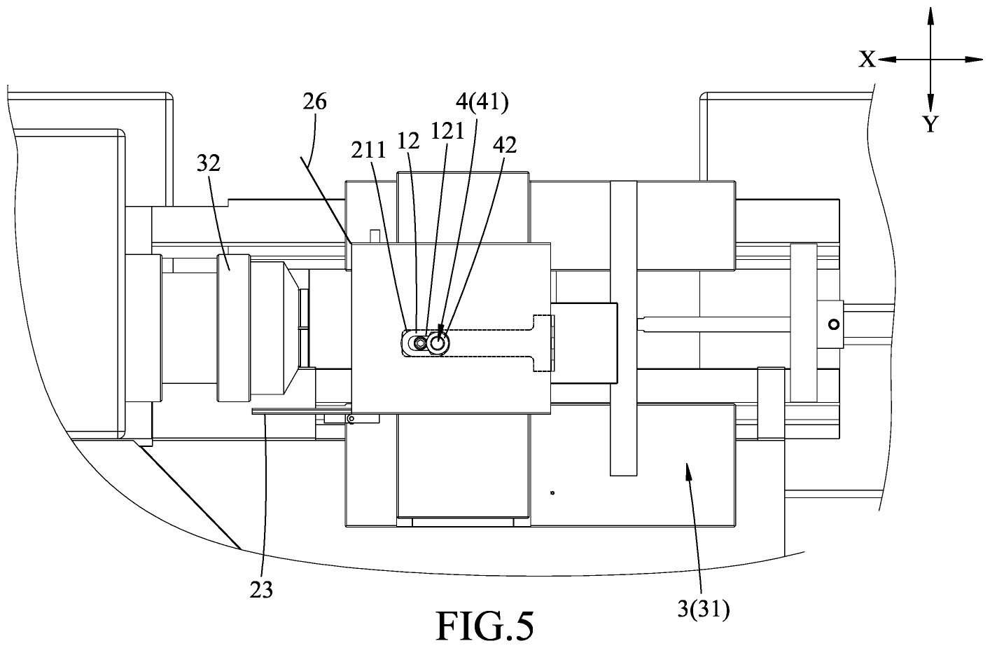

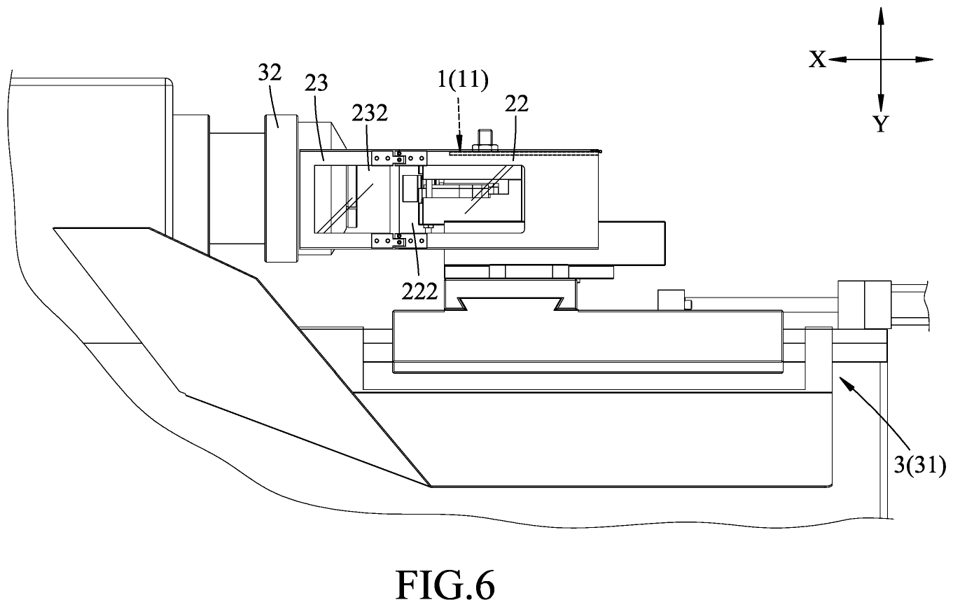

Referring to FIGS. 5 and 6, when a user is located on a side adjacent to the first side plate 22 and operates the lathe 3 for machining operation, a portion of debris generated by the cutter from cutting the workpiece is blocked by the first side plate 22 and the side cover plate 23 to prevent the debris from splashing onto the user. When the other portion of the debris is splashed onto the inclined plate 26, it will fall to a ramp (not shown) located on the other side of the lathe 3 that is adjacent to the second side plate 25 (see FIG. 2), and is collected in a collection unit (not shown) to maintain the lathe 3 in a clean condition. When the distance between the cutter seat 33 (see FIG. 1) and the workpiece seat 32 is changed, the side cover plate 23 is rotated to adjust a blocking range thereof. It should be noted that, in other variations of this embodiment, an opening (not shown) may be drilled in at least one of the first transparent plate 222 and the base plate 21 to facilitate insertion of a nozzle (not shown) of a spray gun into the opening for spraying air onto the machine frame 31 and remove the debris therefrom.

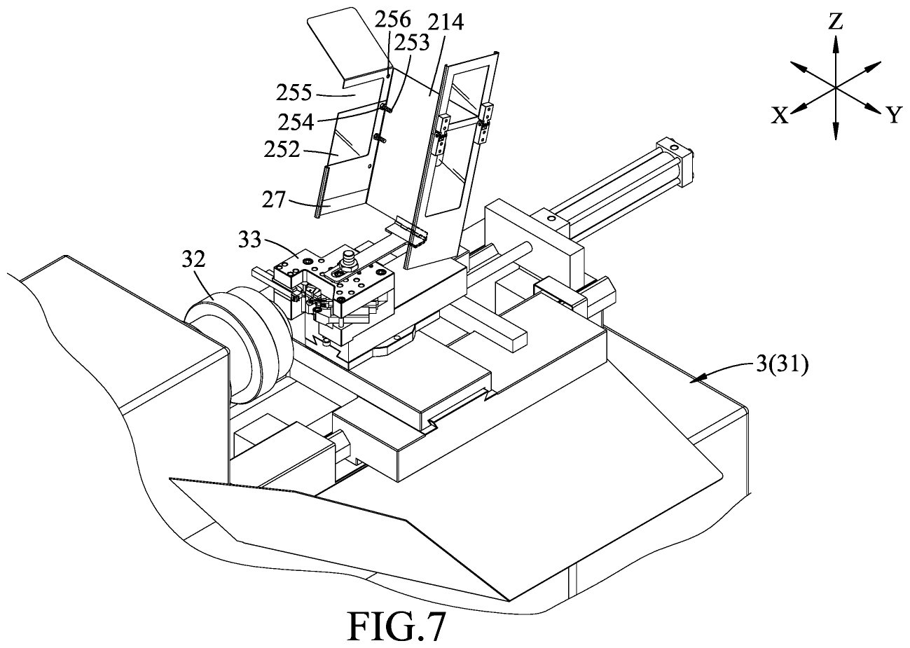

Referring to FIGS. 2, and 7, the second transparent plate 252 can be removed from the second frame-shaped body 251 by disengaging the screw nuts 254 from the screw bolts 253, after which the second binding portions 257 are aligned with two adjacent ones of the first binding portions 256 that are located at the middle. Then, the screw bolts 253 are inserted through the two adjacent middle first binding portions 256 and the second binding portions 257, and the screw nuts 254 are respectively engaged with the screw bolts 253 to fix the second transparent plate 252 to the second frame-shaped body 251. At this time, the second transparent plate 252 partially covers the cutout portion 255, and the shielding space 27 communicates with the outside through the partially covered cutout portion 255. When the cover unit 2 is in the closed position relative to the mounting member 1, the nozzle of the spray gun can be inserted into the partially covered cutout portion 255 to clean the machine frame 31. It should be noted that, in other variations of this embodiment, the number of the first binding portions 256 may be two, and the number of each of the second binding portions 257, the screw bolts 253, and the screw nuts 254 may be one. In this case, by aligning the second binding portion 257 with any one of the first binding portions 256, the effect of adjusting the position of the second transparent plate 252 relative to the second frame-shaped body 251 to completely or partially cover the cutout portion 255 so as to communicate the shielding space 27 with the outside can be similarly achieved.

In summary, through insertion of the threaded bolt 41 through the elongated mounting hole 121, the mounting member 1 of the lathe protective cover 100 of this disclosure can be mounted movably on the cutter seat 33 in the first direction (X). Moreover, by virtue of the cover unit 2 being pivotally connected to the mounting member 1, the cover unit 2 can be easily and conveniently rotated relative to the mounting member 1 to cover the workpiece seat 32 and the cutter seat 33. Furthermore, by rotatably connecting the side cover plate 23 to the first side plate 22, an angle between the side cover plate 23 and the first side plate 22 can be adjusted to thereby adjust a blocking range of the side cover plate 23. Hence, the lathe protective cover 100 of this disclosure can effectively protect the user. In addition, because the inclined plate 26 can guide the splashed debris to fall into a ramp and be collected in a collection unit, a clean working environment can be maintained. Therefore, the object of this disclosure can indeed be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A lathe protective cover adapted to be mounted on a lathe through cooperation of a fixing member, the lathe including a workpiece seat, and a cutter seat movable relative to the workpiece seat in a first direction, said lathe protective cover comprising:
a mounting member having a main body that includes a mounting portion and a pivot portion opposite to said mounting portion, said mounting member being configured to be detachably mounted on one of the cutter seat and the workpiece seat through the fixing member and being configured to be movable relative to the one of the cutter seat and the workpiece seat along the first direction; and
a cover unit including a base plate pivotally connected to said pivot portion and having a through hole, a first side plate connected to one side of said base plate, and a second side plate connected to the other side of said base plate and opposite to said first side plate in a second direction perpendicular to the first direction;
wherein said base plate, said first side plate and said second side plate cooperatively define a shielding space communicating with said through hole; wherein said cover unit is rotatable relative to said mounting member about a first axis between a closed position and an open position;
wherein, when said cover unit is in said closed position relative to said mounting member, said mounting member is located in said shielding space, and said mounting portion is adjacent to said through hole in a third direction perpendicular to the first direction and the second direction; and
wherein, when said cover unit is in said open position relative to said mounting member, said shielding space and said through hole are away from said mounting portion.

2. The lathe protective cover as claimed in claim 1, wherein said mounting portion has a mounting hole for extension of the fixing member therethrough; wherein, when said cover unit is in said closed position relative to said mounting member, said mounting hole is immediately adjacent to and aligned with said through hole in the third direction; and wherein said mounting hole is elongated in the first direction.

3. The lathe protective cover as claimed in claim 2, wherein said mounting hole has an opening area smaller than an opening area of said through hole, and wherein, when said cover unit is in said closed position relative to said mounting member, a profile range of said through hole contains a profile range of said mounting hole.

4. The lathe protective cover as claimed in claim 1, wherein said base plate further has two connecting edges, a pivoting edge connected between said connecting edges and pivotally connected to said pivot portion, and a free end connected between said connecting edges and opposite to said pivoting edge, said first side plate and said second side plate being respectively connected to said two connecting edges of said base plate, said pivot portion being pivotally connected to said pivoting edge of said base plate, said cover unit further including a side cover plate connected to said first side plate and adjacent to said free end of said base plate.

5. The lathe protective case as claimed in claim 4, wherein said side cover plate is rotatably connected to said first side plate for rotation about a second axis perpendicular to the first axis.

6. The lathe protective cover as claimed in claim 5, wherein said cover unit further includes two hinge assemblies disposed between said side cover plate and said first side plate and spaced apart from each other along the second axis, each of said hinge assemblies including a first rod, a second rod, and a hinge pin, said first rod having a first main body connected to one of said side cover plate and said first side plate, and two first pivot lugs protruding from one end of said first main body in a direction away from said one of said side cover plate and said first side plate and spaced apart in the second axis, said second rod having a second main body connected to the other one of said side cover plate and said first side plate, and a second pivot lug protruding from one end of said second main body into a space between said first pivot lugs, said hinge pin being inserted into said first pivot lugs and said second pivot lug along the second axis.

7. The lathe protective cover as claimed in claim 4, wherein said second side plate includes a second frame-shaped body connected to one of said two connecting edges of said base plate, and a second transparent plate disposed on said second frame-shaped body.

8. The lathe protective cover as claimed in claim 7, wherein said second frame-shaped body has a cutout portion and at least two first binding portions, said second transparent plate being detachably disposed on said second frame-shaped body and having at least one second binding portion detachably connected to one of said at least two first binding portions; and wherein, when said at least one second binding portion is connected to said one of said at least two first binding portions, said second transparent plate completely covers said cutout portion, and when said at least one second binding portion is connected to the other one of said at least two first binding portions, said second transparent plate partially covers said cutout portion to communicate said shielding space with the outside through said cutout portion.

9. The lathe protective cover as claimed in claim 4, wherein said cover unit further includes an inclined plate extending inclinedly from a side of said second side plate that is adjacent to said free end of said base plate in a direction away from said first side plate.

10. The lathe protective cover as claimed in claim 4, wherein said side cover plate includes a side cover frame-shaped body connected to said first side plate, and a side cover transparent plate disposed on said first frame-shaped body.
